(19) United States
(12) Patent Application Publication
(10) Pub. No.: US 2008/0283353 A1
(43) Pub. Date: Nov. 20, 2008

(54) Brass Alloy and Synchronizing Ring

(75) Inventors: Meinrad Holderied, Igensdorf (DE); Norbert Gaag, Lauf (DE)

Correspondence Address: LERNER GREENBERG STEMER LLP, P O BOX 2480, HOLLYWOOD, FL, 33022-2480, US

(73) Assignee: DIEHL METALL STIFTUNG & CO. KG, Rothenbach (DE)

(21) Appl. No.: 12/186,675

(22) Filed: Aug. 6, 2008

Related U.S. Application Data
(63) Continuation of application No. PCT/EP2007/001614, filed on Feb. 24, 2007.

(30) Foreign Application Priority Data
Mar. 1, 2006 (DE) 102006009396.8

(51) Int. Cl. C22C 9/05; F16D 13/60

(52) U.S. Cl. 192/107 M; 420/480

(57) ABSTRACT

A wear-resistant brass alloy is ideally suited for manufacturing a synchronizing ring for use in couplings, brakes, transmissions, etc. The brass alloy contains 55-68% by weight of copper, 0-6% by weight of aluminium, 2-14% by weight of manganese, 0.5-3% by weight of phosphorus, 0-1% by weight of lead, unavoidable impurities and the rest zinc.

### CROSS-REFERENCE TO RELATED APPLICATION

This is a continuing application, under 35 U.S.C. § 120, of copending international application No. PCT/EP2007/001614, filed Feb. 24, 2007, which designated the United States; this application also claims the priority, under 35 U.S.C. § 119, of German patent application No. 10 2006 009 396.8, filed Mar. 1, 2006; the prior applications are herewith incorporated by reference in their entirety.

### BACKGROUND OF THE INVENTION

### Field of the Invention

The invention relates to a wear-resistant brass alloy and to a synchronizing ring manufactured from the brass alloy.

For couplings, brakes or transmissions in automobile technology metal friction partners are frequently used. In a mechanical transmission, in particular, metallic synchronizing rings are used which, during a gear change, synchronize the different speeds of the transmission shaft and the selected-gear wheel with one another. Particularly in transmissions for vehicles with high engine power, the synchronizing rings are subject to increased wear due to higher frictional loads. The same applies to automatic-shift transmissions, in which high shift forces are employed. Synchronizing rings are preferably manufactured from a brass alloy.

A wear-resistant brass alloy for a synchronizing ring is known, for example, from German patent DE 37 35 783 C1, corresponding to U.S. Pat. No. 4,954,187.

### SUMMARY OF THE INVENTION

It is accordingly an object of the invention to provide a brass alloy and a synchronizing ring formed from the brass alloy which overcomes the above-mentioned disadvantages of the prior art devices of this general type.

The object is achieved, according to the invention, by a brass alloy containing 55-68% by weight copper, 0-6% by weight of aluminum, 2-14% by weight of manganese, 0.5-3% by weight of phosphorus, 0-1% by weight of lead, unavoidable impurities and the rest zinc.

Comprehensive investigations have yielded the result that a brass alloy having the specified fractions of manganese and phosphorus has high wear resistance and can also be produced on a large industrial scale because the viscosity is suitable for a casting operation. The hardness values of the brass alloy having the specified component fractions vary within a range of between 168 and 229 HB (measured according to DIN EN ISO 6506).

With the hardness values and wear resistances which are achieved, the claimed brass alloy is suitable for withstanding as a synchronizing ring even higher loads in a transmission. Comparable brass alloys according to the prior art which are used for synchronizing rings have wear resistances of between 400 and 600 km/g, along with similar hardness values.

Surprisingly, it was shown, further, that the specified brass alloy has high wear resistance even amongst high-additive transmission oils often used in transmissions because of the increased stress. To be precise, additives contained in transmission oils may have effects on the wear resistance of the brass alloy used for the synchronizing ring.

A synchronizing ring can be produced from the specified brass alloy in a known way by casting, extrusion and forging and also, if appropriate, reannealing.

Lead may be contained or admixed, without a disturbing influence, up to a fraction of 1% by weight, in order to improve the cutting machinability. In this respect, brasses from recycling return may be used to produce the brass alloy. These, as a rule, contain a certain fraction of lead.

The occurrence of a highly viscous melt impedes the casting of the brass alloy. Increased slag formation is likewise to be avoided, since this entails a high outlay for its removal. It was shown that the viscosity of the melt and slag formation can be reduced if aluminum is added to the brass alloy or else the latter contains a low phosphorus fraction. In this case, a higher phosphorus fraction may be compensated by a higher aluminum content. For high wear resistance, along with good castability, the brass alloy advantageously contains 3-6% by weight of aluminum, 8-14% by weight of manganese and 1.5-3% by weight of phosphorus.

In a further advantageous refinement in terms of wear resistance and in terms of large-scale production, the brass alloy advantageously contains 59-64% by weight of copper, 3-4% by weight of aluminum, 9-11% by weight of manganese and 1.9-2.5% by weight of phosphorus.

It was shown, further, that it is advantageous for the wear resistance and hardness of the brass alloy if the fraction of the β-phase of the copper/zinc mixture in the structural make-up amounts to between 40 and 50%. In the β-phase, the copper and zinc atoms are distributed in the manner of a caesium/chloride structure onto the lattice sites of a cubic body-centered lattice.

Further, it became clear that it was advantageous in terms of the desired properties if, in a cross section of the brass alloy, the area fraction of the intermetallic phases in the structural make-up amounts to between 11% and 17%. The intermetallic phases, such as, for example, manganese phosphides, are in this case embedded in a matrix of the copper/zinc alloy.

In particular, the brass alloy exhibits advantageous wear resistance if the intermetallic phases in the structural make-up possess predominantly an extended elongate form.

The second-mentioned object with regard to a synchronizing ring is achieved, according to the invention, by a synchronizing ring which is formed of a brass alloy which contains 55-68% by weight of copper, 0-6% by weight of aluminum, 2-14% by weight of manganese, 0.5-3% by weight of phosphorus, 0-1% by weight of lead, unavoidable impurities and the rest zinc. As already mentioned, the synchronizing ring is produced from the brass alloy by casting, extrusion, forging and, if appropriate, reannealing.

Other features which are considered as characteristic for the invention are set forth in the appended claims.

Although the invention is illustrated and described herein as embodied in a brass alloy and a synchronizing ring, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a graph showing wear resistance of an exemplary brass alloy in various transmission oils according to the invention; and

FIG. 2 is a diagrammatic, front view of a synchronizing ring for a mechanical transmission.

### DETAILED DESCRIPTION OF THE INVENTION

Overall, four test alloys of different composition were produced as exemplary embodiments of the specified brass alloy.

In this case, for realistic measurement results, the production of a synchronizing ring was simulated. Thus, first, the individual alloy components having the desired fractions were melted, and the melt obtained was cast in sand at a temperature of between 1,020 and 1,060° C. with a diameter of 35 mm. The casting was subsequently lathe-turned to a diameter of 24 mm. In a further step, extrusion by a hot-forming of the lathe-turned casting from a diameter of 24 mm to a diameter of 12 mm at a temperature of between 700 and 750° C. was simulated. Further, the forging of the synchronizing ring by the upsetting of 2 cm high cylinders produced from the pretreated casting to 1 cm at a temperature of approximately 750° C. were simulated. Finally, the upset cylinders were annealed for five hours at a temperature of 275° C.

The composition of the four test alloys thus produced is evident from the following Table 1. In this case, the fractions of the individual alloy components are in each case listed in % by weight.

TABLE 1

| Test alloy | | | | | |
|---|---|---|---|---|---|
| No. | Copper | Manganese | Phosphorus | Aluminium | Zinc |
| 1 | 57.5 | 10 | 2.25 | 2 | Rest |
| 2 | 60.35 | 10 | 2.25 | 3 | Rest |
| 3 | 61.78 | 10 | 2.25 | 3.5 | Rest |
| 4 | 63.21 | 10 | 2.25 | 4 | Rest |

The hardness of the test alloys which was determined in each case according to DIN EN ISO 6506 may be gathered from Table 2.

TABLE 2

| Test alloy No. | Hardness HB |
|---|---|
| 1 | 201 |
| 2 | 168 |
| 3 | 187 |
| 4 | 229 |

It is clear from the hardness values determined that the specified brass alloy is suitable for use under high loads as a synchronizing ring in a transmission. The hardness values correspond to those hardness values of comparable brass alloys already used for synchronizing rings.

### EXAMPLE 1

In a first test, the wear resistance of the test alloys, with two transmission oils being used at the same time, was investigated. The transmission oils used were a synthetic oil of viscosity class SAE75 of classification API GL4 (oil 1) and a synthetic oil of viscosity class SAE75W85 of classification API GL4 (oil 2). In transmission oils classified according to API (American Petrol Institute), the GL classes indicate the range of use. Transmission oils of classes GL4 and GL5, for example, are customary for motor vehicles. The designations SAExx-Wyy characterize the viscosity class of transmission oils.

The wear resistance of the test alloys was determined in each case in km/g in a Reichert wear balance with a sliding rate of 1.6 m/sec and with a load of 52 N/mm² after an overall covered distance of 2,500 m. In this case, a brass pin formed of the respective test alloy with a diameter of 2.7 mm is pressed with the specified load onto a continuous steel ring. The respective transmission oil was applied to the steel ring. The measurements were carried out in each case at an oil temperature of 90° C.

The comparative alloy used is a known, wear-resistant brass alloy, which can be taken from German patent DE 37 35 783 C1, of the composition 55% by weight of copper, 6.8% by weight of nickel, 3.7% by weight of aluminium, 2.3% by weight of silicone, 0.8% by weight of iron, the rest zinc and also unavoidable impurities. The wear resistance of the comparative alloy was determined in the same way as that of the test alloys. Table 3 illustrates the determined values of the respective wear resistance of the test alloys as a % of the determined wear resistance of the comparative alloy.

TABLE 3

| | Oil 1 | Oil 2 |
|---|---|---|
| Test alloy No. | Wear resistance in % | Wear resistance in % |
| 1 | 761 | 338 |
| 2 | 618 | 317 |
| 3 | 657 | 329 |
| 4 | 503 | 239 |

It was surprisingly found that, in a measurement with transmission oils, the test alloys have a markedly increased wear resistance, as compared with a known wear-resistant comparative alloy. This advantageous property is ensured by virtue of the specified features of the brass alloy described.

### EXAMPLE 2

In a further test, the wear resistance of the test alloy 3, as indicated in Example 1, for further transmission oils is investigated. The wear resistance for the comparative alloy mentioned in Example 1 is likewise determined, using these transmission oils.

The transmission oils have the following characteristic:

Oil 3:

SAE75W-80, mineral; API GL4

Oil 4:

SAE80W-90, mineral; API GL3

Oil 5:

SAE75W; synthetic, API GL4

Oil 6:

SAE75W, partly synthetic, API GL4

Oil 7:

ATF or automatic oil

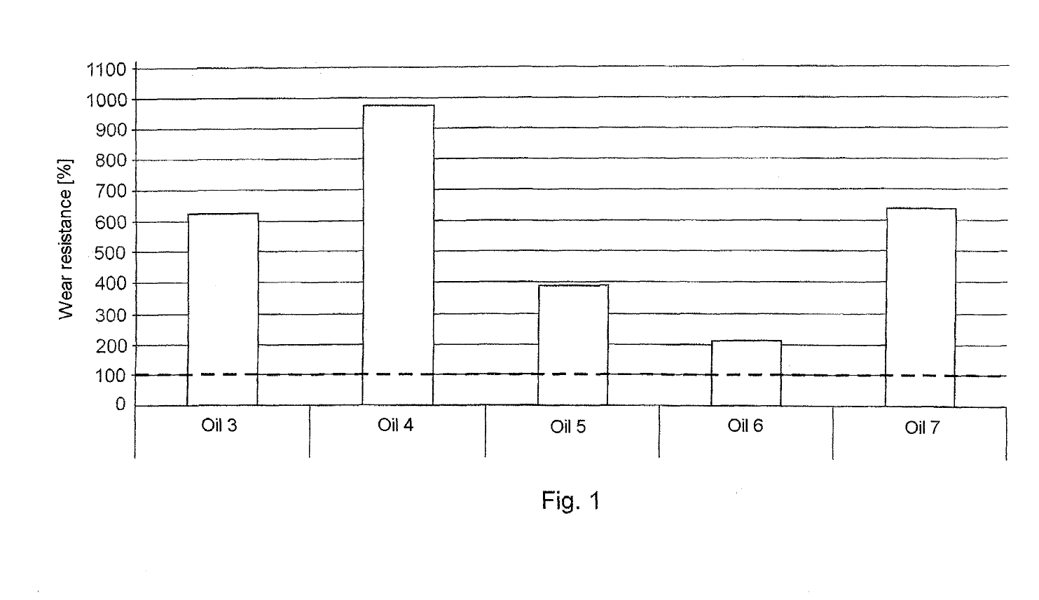

FIG. 1 illustrates the determined wear resistances of the test alloy 3 in % in relation to the respectively determined wear resistance of the comparative alloy, in each case for the various oils. In this case, the percentage wear resistance is plotted along the Y-axis. The various oils are arranged along the X-axis. The wear resistance determined for the comparative alloy is identified by the 100% line. It can be seen clearly that, in all the transmission oils investigated, the test alloy 3 has a markedly increased wear resistance, as compared with the comparative alloy. The specified brass alloy can therefore be used particularly for the high loads of a synchronizing ring in a transmission, such as a rise in reality.

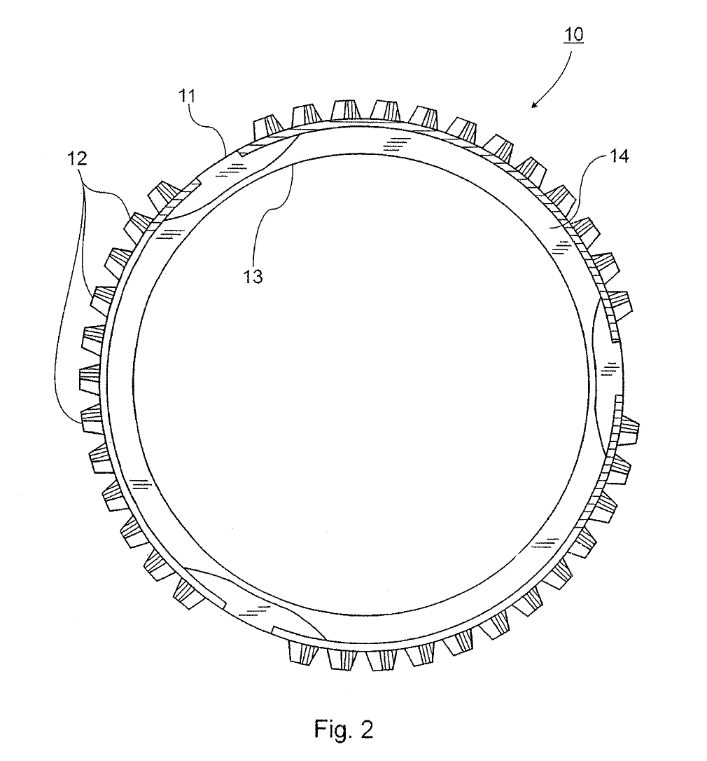

FIG. 2 illustrates a synchronizing ring 10 which is produced by forging from a specified brass alloy. Attached to the outer circumference 11 of the synchronizing ring 10 are teeth 12 which are connected operatively to a sliding sleeve during the synchronizing action between the selected-gear wheel and the transmission shaft of the transmission. On the inner circumference 13 of the synchronizing ring 10 is located a conical friction surface 14 which comes into contact with a conical counter surface of the selected-gear wheel during the shift operation. As a result of the friction of the friction partners, their relative speed with respect to one another is reduced, with the result that synchronization finally takes place. After synchronization has occurred, the sliding sleeve can slide through the teeth 12 of the synchronizing ring 10, with the result that a positive connection is made between the drive shaft and output shaft of the transmission.

1. A brass alloy, comprising:
55-68% by weight of copper;
0-6% by weight of aluminum;
2-14% by weight of manganese;
0.5-3% by weight of phosphorus;
0-1% by weight of lead; and
remainder zinc and impurities.

2. The brass alloy according to claim 1, further comprising:
3-6% by weight of the aluminum;
8-14% by weight of the manganese; and
1.5-3% by weight of the phosphorus.

3. The brass alloy according to claim 1, further comprising:
59-64% by weight of the copper;
3-4% by weight of the aluminum;
9-11% by weight of the manganese; and
1.9-2.5% by weight of the phosphorus.

4. The brass alloy according to claim 1, wherein a structural make-up a fraction of a β-phase amounting to between 40 and 50%.

5. The brass alloy according to claim 1, wherein in a cross section, an area fraction of intermetallic phases in a structural make-up amounting to between 11 and 17%.

6. The brass alloy according to claim 5, wherein said intermetallic phases in said structural make-up possessing predominantly an extended elongate form.

7. A synchronizing ring, comprising:
a brass alloy, containing:
55-68% by weight of copper;
0-6% by weight of aluminum;
2-14% by weight of manganese;
0.5-3% by weight of phosphorus;
0-1% by weight of lead; and
remainder zinc and impurities.
